(19) United States
(12) Patent Application Publication
(10) Pub. No.: US 2026/0128381 A1
(43) Pub. Date: May 7, 2026

(54) ALL-SOLID-STATE BATTERY AND METHOD FOR MANUFACTURING ALL-SOLID-STATE BATTERY

(71) Applicants: Hyundai Motor Company, Seoul (KR); Kia Corporation, Seoul (KR)

(72) Inventors: Sung Ju CHO, Hwaseong-Si (KR); Ju Min Kim, Hwaseong-Si (KR); Jong Hwan Choi, Hwaseong-Si (KR); Yong Hun Lee, Hwaseong-Si (KR); Hyun Geun Kwon, Hwaseong-si (KR); Yong Jun Lee, Hwaseong-Si (KR); Tae Young Kwon, Hweasong-Si (KR); Yoon Seon Kim, Hwaseong-Si (KR)

(73) Assignees: Hyundai Motor Company, Seoul (KR); Kia Corporation, Seoul (KR)

(21) Appl. No.: 19/302,966

(22) Filed: Aug. 18, 2025

(30) Foreign Application Priority Data
Nov. 5, 2024 (KR) 10-2024-0155651

(51) Int. Cl. H01M 10/0585; H01M 4/66

(52) U.S. Cl. CPC H01M 10/0585; H01M 4/66; H01M 2300/0065

(57) ABSTRACT

An all-solid-state battery includes a plurality of first electrodes, each first electrode including a first electrode current collector including a first electrode body and a first electrode tab, and a first electrode active material disposed on the first electrode current collector, a plurality of second electrodes having a polarity different from a polarity of the plurality of first electrodes, and alternately stacked with the plurality of first electrodes in a first direction, each second electrode including a second electrode current collector including a second electrode body and a second electrode tab, and a second electrode active material disposed on the second electrode current collector, and a solid electrolyte interposed between each first electrode and each second electrode.

### CROSS-REFERENCE TO RELATED APPLICATION

The present application claims the benefit of priority to Korean Patent Application No. 10-2024-0155651, filed in the Korean Intellectual Property Office on Nov. 5, 2024, the entire contents of which are incorporated herein by reference.

### TECHNICAL FIELD

The present disclosure relates to an all-solid-state battery and a method for manufacturing an all-solid-state battery.

### BACKGROUND

A secondary battery, which is repeatedly rechargeable unlike a primary battery which is not able to be charged after discharged, is applicable to various fields such as a smartphone, a vehicle, a drone, and a robot, and the importance of the second battery has been increased day by day.

As a second battery according to the related art employs a liquid electrolyte, the second battery is expanded due to the change in temperature, or a leakage from the second battery is caused due to an external impact to cause an explosion or a fire, degrading stability. To solve such a problem, studies and researches have been actively performed on an all-solid-state battery.

As an all-solid-state battery includes a solid electrolyte between a cathode active material and an anode active material, the all-solid-state battery has a higher stability in structure, such that a separator is not required. Accordingly, the all-solid-state battery may be implemented in smaller size and may have a higher energy density. However, in the all-solid-state battery, the electrode active material is expanded and shrunken in a charging/discharging operation. Accordingly, the interface between the electrode active material and the solid electrolyte is de-laminated to degrade the performance of the all-solid-state battery.

Accordingly, to prevent the interface between the electrode active material and the solid electrolyte from being de-laminated, an isostatic pressing process may be performed with respect to the all-solid-state battery. In the instant case, the structure to prevent an electrode tab of an electrode current collector from being broken in the isostatic pressing process has been increasingly required.

### SUMMARY

The present disclosure has been made to solve the above-mentioned problems occurring in the related art while advantages achieved by the related art are maintained intact.

An aspect of the present disclosure provides an all-solid-state battery, configured for preventing an electrode tab from being broken in an isostatic pressing process, and a method for manufacturing all-solid-state battery.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an all-solid-state battery includes a plurality of first electrodes, each first electrode including a first electrode current collector including a first electrode body and a first electrode tab, and a first electrode active material disposed on the first electrode current collector, a plurality of second electrodes having a polarity different from a polarity of the plurality of first electrodes, and alternately stacked with the plurality of first electrodes in a first direction, each second electrode including a second electrode current collector including a second electrode body and a second electrode tab, and a second electrode active material disposed on the second electrode current collector, and a solid electrolyte interposed between each first electrode and each second electrode. Each first electrode tab and each second electrode tab protrude from the first electrode body and the second electrode body, respectively, in a second direction crossing the first direction. A part, in which the first electrode tabs of the plurality of first electrodes make contact with each other, or a part, in which the second electrode tabs of the plurality of second electrodes make contact with each other, is spaced apart in the first direction from the first electrode or the second electrode, which is positioned at opposite ends, which are disposed in the first direction, of the plurality of first electrodes and the plurality of second electrodes.

The first electrode tabs of the plurality of first electrodes may make contact with each other at one side of the first electrode body and the second electrode body in the second direction, and the second electrode tabs of the plurality of second electrodes may make contact with an opposite side of the first electrode body and the second electrode body in the second direction.

The first electrode active material may have an area greater than an area of the second electrode active material.

According to an aspect of the present disclosure, the all-solid-state battery may further include an edge member disposed along a circumference of the second electrode active material to make contact with the second electrode tab.

The first electrode may be disposed as an anode, and the second electrode may be disposed as a cathode.

According to an aspect of the present disclosure, a method for providing an all-solid-state battery may include stacking, in a first direction, at least one first electrode, at least one second electrode disposed to have a polarity different from a polarity of the at least one first electrode, and at least one solid electrolyte interposed between the at least one first electrode and the at least one second electrode, stacking the at least one first electrode, the at least one second electrode, and the at least one solid electrolyte on a jig plate and packing a result structure using an exterior material, and pressing the at least one first electrode, the at least one solid electrolyte, the at least one second electrode, which are packed, in the first direction. The first electrode may include a first electrode current collector including a first electrode body and a first electrode tab protruding from the first electrode body, in a second direction crossing the first direction, and the second electrode includes a second electrode current collector including a second electrode body and a second electrode tab protruding from the second electrode body in the second direction. The at one least first electrode tab and the at least one second electrode tab and the at least one solid electrolyte may be stacked on the jig plate and the first electrode tab and the second electrode tab may be spaced apart from the jig plate in the first direction.

Opposite ends of the jig plate in the second direction may be disposed inwardly from opposite ends, which are disposed in the second direction, of the first electrode body in the second direction, or disposed at positions in line with positions of the opposite ends, which are disposed in the second direction, of the first electrode body, in the first direction.

Each of opposite ends, which are disposed in the second direction, of the jig plate may be interposed between each of opposite ends, which are disposed in the second direction, of the first electrode body and each of opposite ends, which are disposed in the second direction, of the second electrode body.

The packing of the at least one first electrode, the at least one solid electrolyte, the at least one second electrode, using the exterior material may include additionally disposing a protective film between the jig plate, and the first electrode or the second electrode, which is positioned at one end, which is disposed in the first direction, of the at least one first electrode and the at least one second electrode and packing the protective film together with the at least one first electrode, the at least one solid electrolyte and the at least one second electrode using the exterior material.

The opposite ends, which are disposed in the second direction, of the protective film may be disposed outwardly from opposite ends, which are disposed in the second direction, of the jig plate in the second direction, or disposed at positions in line with positions of the opposite ends, which are disposed in the second direction, of the jig plate, in the first direction.

The packing of the at least one first electrode, the at least one solid electrolyte, and the at least one second electrode, using the exterior material may include packing an internal exterior material and the jig plate together using the exterior material so that the internal exterior material and the jig plate are surrounded by the exterior material, after surrounding the at least one first electrode, and the at least one second electrode by the internal exterior material.

The jig plate may include a jig plate body, and a jig plate cover disposed at opposite sides of the jig plate body in the second direction, and the jig plate may cover may include an elastic member.

Opposite ends, which are disposed in the second direction, of the jig plate may be disposed inwardly from opposite ends, which are disposed in the second direction, of the first electrode body in the second direction, or disposed at positions in line with positions of the opposite ends, which are disposed in the second direction, of the first electrode body, in the first direction.

Each of opposite ends, which are disposed in the second direction, of the jig plate cover may be interposed between each of opposite ends, which are disposed in the second direction, of the first electrode body and each of opposite ends, which are disposed in the second direction, of the second electrode body.

According to an aspect of the present disclosure, a method for manufacturing an all-solid-state battery may further include unpacking the exterior material packed, after pressing the at least one first electrode, the at least one solid electrolyte, and the at least one second electrode, which are packed, and additionally stacking a plurality of first electrodes, a plurality of solid electrolytes, and a plurality of second electrodes.

According to an aspect of the present disclosure, a method for manufacturing an all-solid-state battery may include bringing first electrode tabs of the plurality of first electrodes into contact with each other and bonding the first electrode tabs to a first lead and bringing second electrode tabs of the plurality of second electrode into contact with each other and bonding the second electrode tabs to a second lead after stacking the plurality of first electrodes, the plurality of solid electrolytes, and the plurality of second electrodes.

According to an aspect of the present disclosure, a method for manufacturing an all-solid-state battery may include packing the plurality of first electrodes, the plurality of solid electrolytes, and the plurality of second electrodes, which are stacked.

### BRIEF DESCRIPTION OF THE DRAWINGS

The above and other objects, features and advantages of the present disclosure will be more apparent from the following detailed description taken in conjunction with the accompanying drawings:

FIG. 1 is a vertical sectional view of an all-solid-state battery, according to an exemplary embodiment of the present disclosure;

FIG. 2 is a flowchart illustrating a method for manufacturing an all-solid-state battery, according to an exemplary embodiment of the present disclosure;

FIG. 3 is a vertical sectional view of a unit pressing stack structure in a pressing step of a method for manufacturing an all-solid-state battery, according to an exemplary embodiment of the present disclosure;

FIG. 4 is a vertical sectional view of a unit pressing stack structure in a pressing step of a method for manufacturing an all-solid-state battery, according to another embodiment of the present disclosure.

FIG. 5 is a vertical sectional view of a unit pressing stack structure in a pressing step of a method for manufacturing an all-solid-state battery, according to still another embodiment of the present disclosure;

FIG. 6 is a vertical sectional view of a unit pressing stack structure in a pressing step of a method for manufacturing an all-solid-state battery, according to still another embodiment of the present disclosure;

FIG. 7 is a vertical sectional view of a unit pressing stack structure in a pressing step of a method for manufacturing an all-solid-state battery, according to still another embodiment of the present disclosure; and

FIG. 8 is a vertical sectional view of a unit pressing stack structure in a pressing step of a method for manufacturing an all-solid-state battery, according to still another embodiment of the present disclosure.

### DETAILED DESCRIPTION

Hereinafter, various exemplary embodiments of the present disclosure will be described in detail with reference to accompanying drawings. In the following description, the same reference numerals will be assigned to the same components even though the elements are illustrated in different drawings. In addition, in the following description of an exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

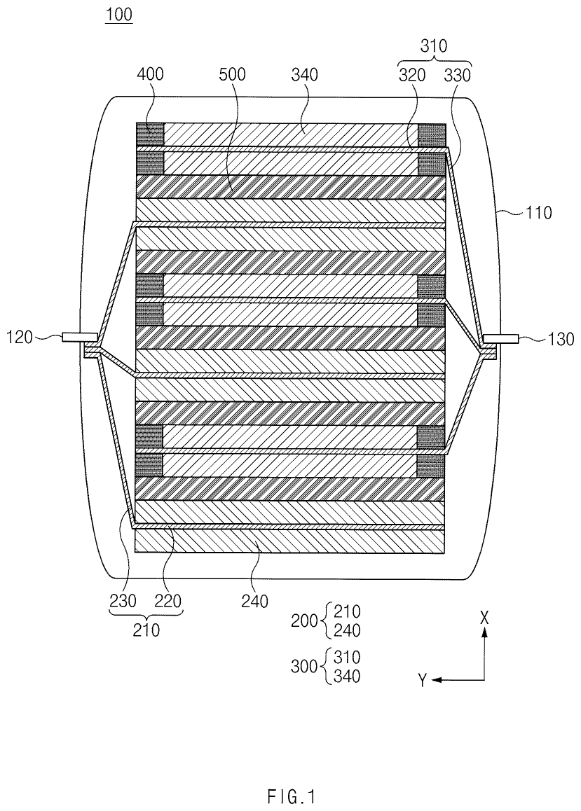

Hereinafter, embodiments of the present disclosure will be described in detail with reference to FIGS. 1 to 8.

FIG. 1 is a vertical sectional view of an all-solid-state battery, according to an exemplary embodiment of the present disclosure.

Referring to FIG. 1, an all-solid-state battery 100 may include a first electrode 200, a second electrode 300 stacked on the first electrode 200 and having a polarity different from a polarity of the first electrode 200, and a post exterior material 110 disposed to surround the first electrode 200 and the second electrode 300. The first electrode 200 may be an anode, and the second electrode 300 may be a cathode.

The all-solid-state battery 100 may be disposed, as a plurality of first electrodes 200 and a plurality of second electrodes 300 are alternately stacked on each other in a first direction (an X direction or a direction opposite to the X direction). The first electrode 200 may include a first electrode current collector 210 and a first electrode active material 240 disposed on the first electrode current collector 210. First electrode active materials 240 may be disposed on opposite surfaces, which face opposite sides (the X direction or the direction opposite to the X direction) of the first direction, of the first electrode current collector 210. Alternatively, the first electrode active material 240 may be disposed only one surface of the first electrode current collector 210.

The second electrode 300 may include a second electrode current collector 310 and a second electrode active material 340 disposed on the second electrode current collector 310. Second electrode active materials 340 may be disposed on opposite surfaces, which face opposite sides (the X direction or the direction opposite to the X direction) of the first direction, of the second electrode current collector 310. Alternatively, the second electrode active material 340 may be disposed only one surface of the second electrode current collector 310.

The first electrode current collector 210 may be formed of nickel (Ni), but the present disclosure is not limited thereto. Furthermore, the second electrode current collector 310 may be formed of aluminum (Al), but the present disclosure is not limited thereto.

The first electrode current collector 210 may include a first electrode body 220 and a first electrode tab 230 protruding from the first electrode body 220 toward one side (a Y direction) of a second direction. The second electrode current collector 310 may include a second electrode body 320 and a second electrode tab 330 protruding from the second electrode body 320 toward an opposite side (a direction opposite to the Y direction) of the second direction.

The first electrode body 220 of the first electrode current collector 210 may be coated with the first electrode active material 240. Similarly, the second electrode body 320 of the second electrode current collector 310 may be coated with the second electrode active material 340.

A part, in which first electrode tabs 230 of the plurality of first electrodes 200 make close contact with each other, is spaced apart in the first direction from the first electrode 200 or the second electrode 300 which is positioned at opposite end portions of the plurality of first electrodes 200 and the plurality of second electrodes 300 in the first direction.

In more detail, the plurality of first electrode tabs 230 may make close contact with each other, at one sides (the Y direction), which are disposed in the second direction, of the plurality of first electrode bodies 220 and the plurality of second electrode bodies 320. The plurality of first electrode tabs 230, which make close contact with each other, may be connected to a first lead 120.

A part, in which second electrode tabs 330 of the plurality of second electrodes 300 make close contact with each other, is spaced apart in the first direction from the first electrode 200 or the second electrode 300 which is positioned at the opposite end portions of the plurality of first electrodes 200 and the plurality of second electrodes 300 in the first direction.

In more detail, the plurality of second electrode tabs 330 may make close contact with each other, at opposite sides (the direction opposite to the Y direction), which are disposed in the second direction, of the plurality of first electrode bodies 220 and the plurality of second electrode bodies 320. The plurality of second electrode tabs 330, which make close contact with each other, may be connected to a second lead 130.

The post exterior material 110 of the all-solid-state battery 100 may be disposed to surround the stack structure of the first electrode 200 and the second electrode 300, together with portions of first and second leads 120 and 130.

Meanwhile, the all-solid-state battery 100 may include a solid electrolyte 500 interposed between the first electrode 200 and the second electrode 300. The all-solid-state battery 100 may include the solid electrolyte 500, which is in a solid phase, without an additional separator between the first electrode 200 and the second electrode 300, which is different from a lithium ion battery. The all-solid-state battery 100 may be manufactured through a process for coating or transferring the solid electrolyte 500 on one surface, which faces the second electrode 300, of the first electrode 200.

Since the all-solid-state battery 100 includes the solid electrolyte 500 including solid particles, the all-solid-state battery 100 needs to be pressed in the stack direction of the first electrode 200 and the second electrode 300 to form an interface between the solid electrolyte 500 and the first electrode 200 or the solid electrolyte 500 and the second electrode 300, which is different from the lithium ion battery. For example, an isostatic pressing process (Warm Isostatic Press; WIP) needs to be performed with respect to the all-solid-state battery 100.

Furthermore, when the first electrode 200 and the second electrode 300 are viewed at a position spaced apart in the first direction, the first electrode body 220 may have a size greater than a size of the second electrode body 320. In other words, the first electrode active material 240 may have an area greater than an area of the second electrode active material 340.

This is to prevent a short circuit from occurring between the first electrode 200 and the second electrode 300, due to a dendrite which is a phenomenon where lithium crystals nucleate and grow on the surface of the first electrode 200, as the all-solid-state battery 100 is repeatedly charged and discharged.

To prevent the short circuit, an area of the first electrode active material 240 disposed on the first electrode body 220 may be greater than an area of the second electrode active material 340 disposed on the second electrode body 320.

As described above, the all-solid-state battery 100 may include an edge member 400 disposed along the circumference of the second electrode active material 340 to make contact with the second electrode 330, to prevent the first electrode tab 230 and the second electrode tab 330 from being broken, due to the difference in area between the first electrode active material 240 and the second electrode active material 340.

The edge member 400 may be disposed to support the first electrode active material 240 disposed outwardly from the second electrode active material 340 in the second direction (the Y direction or the direction opposite to the Y direction) or a third direction (opposite directions perpendicular to the X direction and the Y direction). The edge member 400 may be formed of Polyethylene Terephthalate (PET), but the present disclosure is not limited thereto.

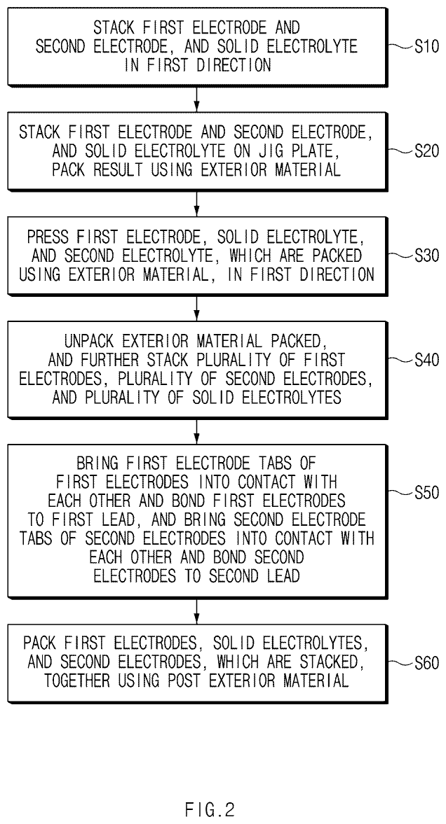

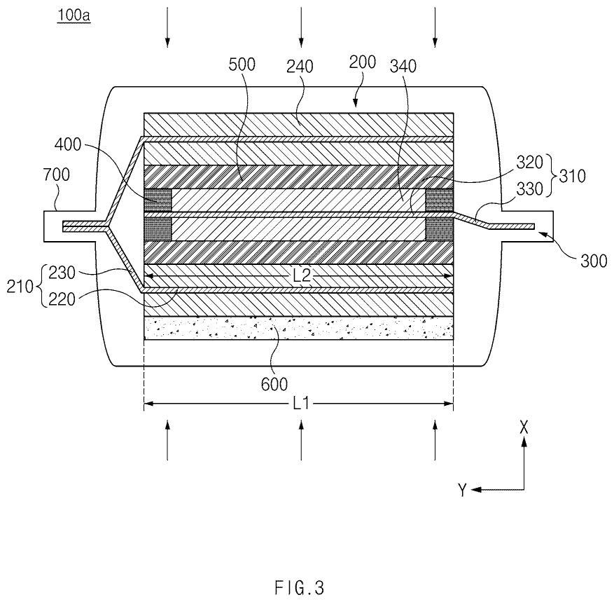

FIG. 2 is a flowchart illustrating a method for manufacturing an all-solid-state battery, according to an exemplary embodiment of the present disclosure. FIG. 3 is a vertical sectional view of a unit pressing stack structure in a pressing step of a method for manufacturing an all-solid-state battery, according to an exemplary embodiment of the present disclosure.

Referring to FIGS. 2 and 3, the method for manufacturing the all-solid-state battery 100 (see FIG. 1) may include a stacking step (S10), an intermediate packing step (S20), a pressing step (S30), a post-stacking step (S40), a connecting step (S50), and a post-packing step (S60).

The stacking step (S10) may be to stack at least one electrode 200, at least one second electrode 300, and at least one solid electrolyte 500 interposed between the at least one first electrode 200 and the at least one second electrode 300 in the first direction.

Furthermore, the stacking step (S10) may include bringing the edge member 400, which extends along the circumference of the second electrode active material 340, into contact with the second electrode tab 330.

In the stacking stage (S10), a pair of first electrodes 200 may be disposed, or one second electrode 300 may be disposed, but the present disclosure is not limited thereto.

The intermediate packing step (S20) may be to stack the at least one first electrode 200, the at least one second electrode 300, and the at least one solid electrolyte 500 on a jig plate 600, and packaging the stack structure using an exterior material 700, after the stacking step (S10).

The pressing step (S30) may be to press the at least one first electrode 200 and the at least one second electrode 300 in the first direction (the X direction or the direction opposite to the X direction), after the intermediate packing step (S20), as illustrated in FIG. 3. The pressing step (S30) may be to perform the isostatic pressing process described above.

In other words, the pressing step (S30) may be to press the at least one first electrode 200, the at least solid electrolyte 500, and the at least second electrode 300, which are packed, in the first direction. In the instant case, the at least one first electrode 200, the at least one solid electrolyte 500, and the at least one second electrode 300 may be supported on the jig plate 600 and packed together with the jig plate 600.

The pressing step S30 may be to perform pressing by the strength of 450 MPa in the first direction under an environment of 100 degrees Celsius to interfaces between the first electrode 200 and the solid electrolyte 500, and between the second electrode 300 and the solid electrolyte 500.

As illustrated in FIG. 3, a unit pressing stack structure 100a may include the at least one first electrode 200, the at least one second electrode 300, the at least one solid electrolyte 500, and the jig plate 600. Furthermore, the unit pressing stack structure 100a may include the exterior material 700 to pack the at least one first electrode 200, the at least one second electrode 300, and the jig plate 600 together.

When the at least one first electrode 200, the at least one second electrode 300, and the at least one solid electrolyte 500 are stacked on the jig plate 600, the first electrode tab 230 and the second electrode tab 330 may be spaced apart from the jig plate 600, in the first direction. In more detail, at least one first electrode tab 230 and at least one second electrode tab 330 may be spaced apart from opposite ends, which are disposed in the second direction, of the jig plate 600, in the first direction.

Meanwhile, the opposite ends, which are disposed in the second direction, of the jig plate 600 may be disposed inwardly from the opposite ends, which are disposed in the second direction, of the first electrode body 220 in the second direction, or may be disposed at positions in line with the opposite ends, which are disposed in the second direction, of the first electrode body 220, in the first direction.

A length L2 of the first electrode body 220 in the second direction may be equal to a length L1 of the jig plate 600 in the second direction, or may have the difference of 1 mm from the length of the jig plate 600. Furthermore, the first electrode body 220 and the jig plate 600 may not be disposed to protrude with respect to each other in the second direction.

According to such a structure, when the isostatic pressing process is performed in the first direction in the pressing step (S30), the jig plate 600 presses the first electrode body 220 and the second electrode body 320 without pressing at least one first electrode tab 230 and at least one second electrode tab 330.

When the at least one first electrode tab 230 and the at least one second electrode tab 330 do not make contact with the jig plate 600 in the pressing step (S30), the first electrode tab 230 and the second electrode tab 330 may be prevented from being broken, improving the productivity of the all-solid-state battery 100 (see FIG. 1).

The post-stacking step (S40) may be to unpack the exterior material 700 packed after the pressing step (S30) and additionally stack the plurality of first electrodes 200 and the plurality of second electrodes 300 as illustrated in FIG. 1.

The post-stacking step (S40) may include interposing the solid electrolyte 500 between the first electrode 200 and the second electrode 300.

In other words, the post-stacking step (S40) may further include the step for unpacking the exterior material 700, and further stacking the plurality of first electrodes 200, the plurality of solid electrolytes 500, and the plurality of second electrodes 300, after pressing the at least one first electrode 200, the at least one solid electrolyte 500, and the at least one second electrode 300.

The connecting step (S50) may be to bring first electrode tabs 230 of the plurality of first electrodes 200 into close contact with each other and bond the first electrodes 200 to the first lead 120, and to bring second electrode tabs 330 of the plurality of second electrodes 300 into close contact with each other and bond the second electrodes 300 to the second lead 130, after the post-stacking step (S40).

In other words, the connecting step (S50) may be to bring first electrode tabs 230 of the plurality of first electrodes 200 into close contact with each other and bond the first electrodes 200 to the first lead 120, and to bring second electrode tabs 330 of the plurality of second electrodes 300 into close contact with each other and bond the second electrodes 300 to the second lead 130, after stacking the plurality of first electrodes 200, the plurality of solid electrolytes 500, and the plurality of second electrodes 300.

The post-packing step (S60) may be to surround the plurality of first electrodes 200 and the plurality of second electrodes 300, which are stacked, using a post exterior material 110, after the connecting step (S50).

In other words, the post-packing step (S60) may be to pack the plurality of first electrodes 200, the plurality of solid electrolytes 500, and the plurality of second electrodes 300, which are stacked, together using the post exterior material 110.

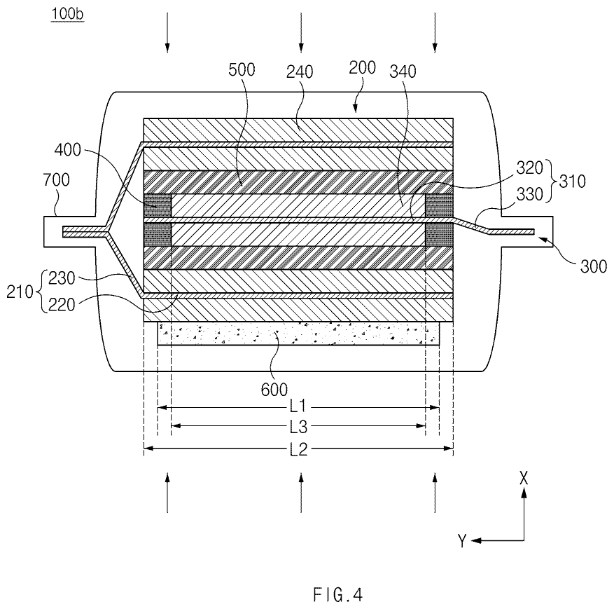

FIG. 4 is a vertical sectional view of a unit pressing stack structure in a pressing step of a method for manufacturing an all-solid-state battery, according to another embodiment of the present disclosure.

Referring to FIG. 4, a unit pressing stack structure 100b may be different from the unit pressing stack structure 100a illustrated in FIG. 3, in the length L1 of the jig plate 600 in the second direction and the placement of the jig plate 600, when compared with the unit pressing stack structure 100a.

The jig plate 600 may be placed on the central region of the first electrode 200 in the second direction. The component and the structure, which are not illustrated in FIG. 4, may be understood by citing the structure of FIG. 3.

In more detail, the length L1 of the jig plate 600 in the second direction may be shorter than the length L2 of the first electrode body 220 in the second direction, and to be longer than the length L3 of the second electrode body 320 in the second direction.

The each of opposite ends, which are disposed in the second direction, of the jig plate 600 may be disposed between each of opposite ends, which are disposed in the second direction, of the first electrode body 220 and each of the opposite ends, which are disposed in the second direction, of the second electrode body 320.

Even in such a structure, in the pressing step (S30), the jig plate 600 presses the first electrode body 220 and the second electrode body 320 without pressing at least one first electrode tab 230 and at least one second electrode tab 330. Accordingly, the at least one first electrode tab 230 and the at least one second electrode tab 330 are prevented from making contact with the jig plate 600, so that the first electrode tab 230 and the second electrode tab 330 may be prevented from being broken, improving the productivity of the all-solid-state battery 100 (see FIG. 1).

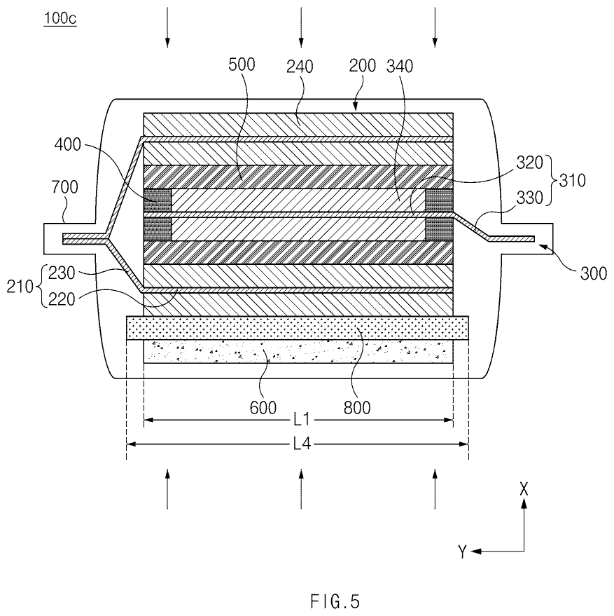

FIG. 5 is a vertical sectional view of a unit pressing stack structure in a pressing step of a method for manufacturing an all-solid-state battery, according to still another embodiment of the present disclosure.

Referring to FIG. 5, a unit pressing stack structure 100c may further include a protective film 800, when compared to the unit pressing stack structure 100a illustrated in FIG. 3.

In other words, the intermediate packing step S20 (see FIG. 2) of the all-solid-state battery 100 (see FIG. 1), the protective film 800 may be further interposed between the first electrode 200 or the second electrode 300, which is positioned at one end portion of the at least one first electrode 200 and the at least one second electrode 300 in the first direction, and the jig plate 600.

In other words, in the structure illustrated in FIG. 5, the packing of the at least one first electrode 200, the at least one solid electrolyte 500, and the at least one second electrode 300 using the exterior material 700 may include further interposing the protective film 800 between the first electrode 200 or the second electrode 300, which is positioned at one end portion of the at least one first electrode 200 and the at least one second electrode 300 in the first direction, and the jig plate 600, and packing the protective film 800 together with the structure using the exterior material 700.

The component and the structure, which are not illustrated in FIG. 5, may be understood by citing the structure of FIG. 3.

The protective film 800 may be stacked on the jig plate 600, and the at least one first electrode 200 and the at least one second electrode 300 may be stacked on the protective film 800. The protective film 800 may include a polymer material and may be a component to protect the at least one first electrode 200 and the at least one second electrode 300 from being pressed by stronger force from the jig plate 600.

Although the protective film 800 includes polyimide, the present disclosure is not limited thereto. For example, the protective film 800 may include various materials, as long as the protective film 800 may reduce pressure to be transmitted at least one the first electrode 200 or the at least one second electrode 300 from the jig plate 600.

The opposite ends, which are disposed in the second direction, of the protective film 800 may be disposed outwardly from the opposite ends, which are disposed in the second direction, of the jig plate 600 in the second direction, or may be disposed at positions in line with the opposite ends, which are disposed in the second direction, of the jig plate 600, in the first direction.

In other words, a length L4 of the protective film 800 in the second direction may be longer than the length L1 of the jig plate 600 in the second direction. The length L1 of the jig plate 600 in the second direction may be equal to a length L2 (see FIG. 3) of the first electrode body 220 in the second direction.

Even in such a structure, in the pressing step (S30), the jig plate 600 presses the first electrode body 220 and the second electrode body 320 through the protective film 800 without pressing at least one first electrode tab 230 and at least one second electrode tab 330. The at least one first electrode tab 230 and the at least one second electrode tab 330 may be prevented from being broken by the jig plate 600. Accordingly, the productivity of the all-solid-state battery 100 may be improved.

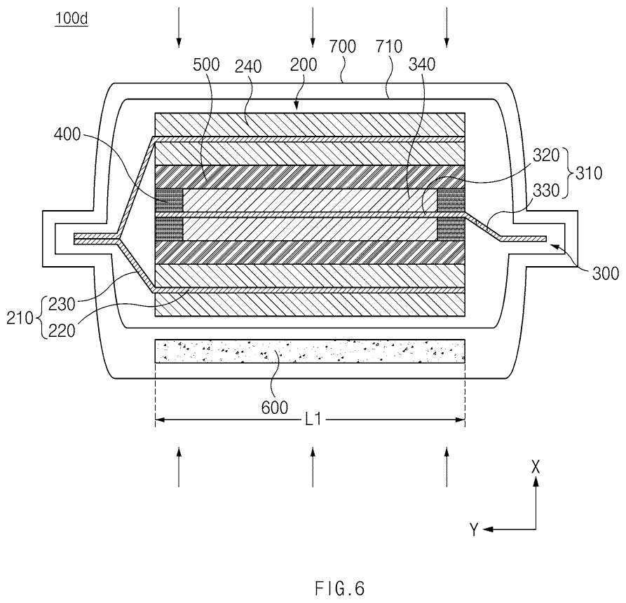

FIG. 6 is a vertical sectional view of a unit pressing stack structure in a pressing step of a method for manufacturing an all-solid-state battery, according to still another embodiment of the present disclosure.

Referring to FIG. 6, a unit pressing stack structure 100d may include an internal exterior material 710 to surround at least one of the first electrode 200 and the second electrode 300. The internal exterior material 710 may be a component to surround the at least one of the first electrode 200 and the second electrode 300, before stacking the at least one of the first electrode 200 and the second electrode 300 on the jig plate 600.

The component and the structure, which are not illustrated in FIG. 6, may be understood by citing the structure of FIG. 3.

The at least one of the first and second electrodes 200 and 300 may be surrounded by the internal exterior material 710 and then may be stacked on the jig plate 600. Thereafter, the at least one of the first and second electrodes 200 and 300, the internal exterior material 710, and the jig plate 600 may be surrounded by the exterior material 700.

In the instant case, the length L1 of the jig plate 600 in the second direction may be equal to the length of the first electrode body 220 in the second direction, or may have the difference of 1 mm from the length of the first electrode body 220 in the second direction. Furthermore, the opposite ends, which are disposed in the second direction, of the jig plate 600 may be disposed at positions in line with positions of the opposite ends, which are disposed in the second direction, of the first electrode 200 in the first direction.

In other words, in the intermediate packing step (S20) of the unit pressing stack structure 100d illustrated in FIG. 6, may include packing the internal exterior material 710 and the jig plate 600 together using the exterior material 700 so that the internal exterior material 710 and the jig plate 600 are surrounded by the exterior material 700, after surrounding the at least one first electrode 200, the at least one solid electrolyte 500, and the at least one second electrode 300 by the internal exterior material 710.

In other words, the packing of the at least one first electrode 200, the at least one solid electrolyte 500, and the at least one second electrode 300 using the exterior material 700 may include packing the internal exterior material 710 and the jig plate 600 together using the exterior material 700 so that the internal exterior material 710 and the jig plate 600 are surrounded by the exterior material 700, after surrounding the at least one first electrode 200, the at least one solid electrolyte 500, and the at least one second electrode 300 by the internal exterior material 710.

Even in such a structure, in the pressing step (S30), the jig plate 600 presses the first electrode body 220 and the second electrode body 320 without pressing at least one first electrode tab 230 and at least one second electrode tab 330. Accordingly, at least one first electrode tab 230 and the at least one second electrode tab 330 may be prevented from being broken, so that the productivity of the all-solid-state battery 100 may be improved.

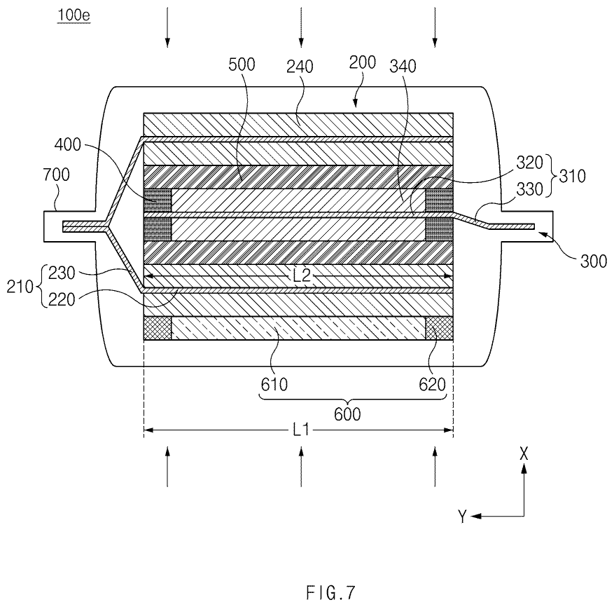

FIG. 7 is a vertical sectional view of a unit pressing stack structure in a pressing step of a method for manufacturing an all-solid-state battery, according to still another embodiment of the present disclosure.

Referring to FIG. 7, the jig plate 600 of a unit pressing stack structure 100e may include a jig plate body 610 and a jig plate cover 620. The component and the structure, which are not illustrated in FIG. 7, may be understood by citing the structure of FIG. 3.

The length L1 of the jig plate 600 in the second direction may be equal to the length 12 of the first electrode body 220 in the second direction, or may have the difference of 3 mm from the length of the first electrode body 220 in the second direction.

The jig plate cover 620 may be disposed at opposite sides of the jig plate body 610 in the second direction. The jig plate cover 620 may include an elastic member. The jig plate cover 620 may be a component to prevent the at least one first electrode tab 230 and at least one second electrode tab 330 from being broken, as the at least one first electrode tab 230 and at least one second electrode tab 330 make contact with the jig plate body 610. Each of opposite ends, which are disposed in the second direction, of the jig plate cover 620 may be interposed between each of opposite ends, which are disposed in the second direction, of the first electrode body 220 and each of opposite ends, which are disposed in the second direction, of the second electrode body 320.

In other words, the jig plate cover 620 includes a material including elasticity stronger than elasticity of the jig plate body 610. Accordingly, when the isostatic pressing process is performed with respect to the unit pressing stack structure 100e in the pressing step S30, the at least one first electrode tab 230 and at least one second electrode tab 330 may be prevented from being broken, even if the at least one first electrode tab 230 and at least one second electrode tab 330 make contact with the jig plate cover 620.

Furthermore, as the at least one first electrode body 220 and the at least one second electrode body 320 are pressed from the jig plate body 610 in the first direction, the interfaces may be disposed as much as possible, between the first electrode 200 and the solid electrolyte 500, and between the second electrode 300 and the solid electrolyte 500.

Even in the instant case, in the pressing step (S30), the jig plate 600 presses the first electrode body 220 and the second electrode body 320 without pressing at least one first electrode tab 230 and at least one second electrode tab 330. Accordingly, as at least one first electrode tab 230 and the at least one second electrode tab 330 may be prevented from being broken by the jig plate 600, the productivity of the all-solid-state battery 100 may be improved.

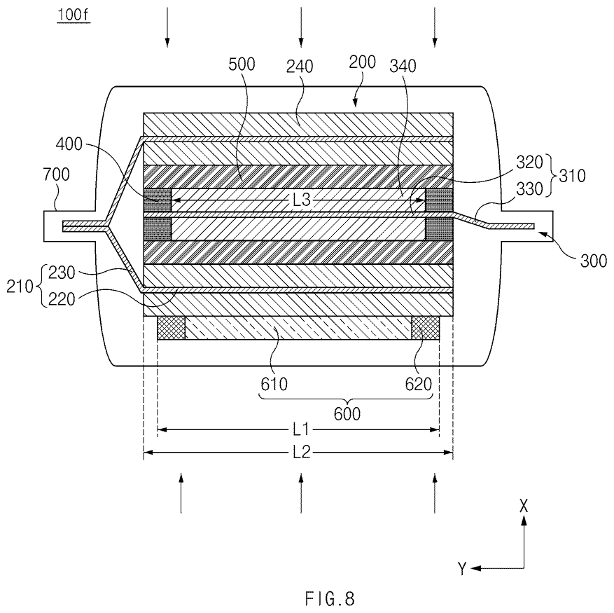

FIG. 8 is a vertical sectional view of a unit pressing stack structure in a pressing step of a method for manufacturing an all-solid-state battery, according to still another embodiment of the present disclosure.

Referring to FIG. 8, the jig plate 600 of a unit pressing stack structure 100f may include a jig plate body 610 and a jig plate cover 620. The component and the structure, which are not illustrated in FIG. 8, may be understood by citing the structure of FIG. 3.

In more detail, the length L1 of the jig plate 600 in the second direction may be shorter than the length L2 of the first electrode body 220 in the second direction, and longer than the length L3 of the second electrode body 320 in the second direction.

Opposite ends, which are disposed in the second direction, of the jig plate 600 may be disposed inwardly from the opposite ends, which are disposed in the second direction, of the first electrode body 220 in the second direction, or may be disposed at positions in line with positions the opposite ends, which are disposed in the second direction, of the first electrode body 220, in the first direction.

In more detail, each of the opposite ends, which are disposed in the second direction, of the jig plate 620 may be disposed between each of the opposite ends, which are disposed in the second direction, of the first electrode body 220 and each of opposite ends, which are disposed in the second direction, of the second electrode body 320.

Meanwhile, the opposite ends, which are disposed in the second direction, of the jig plate 600 may be disposed inwardly from the opposite ends, which are disposed in the second direction, of the first electrode body 220 in the second direction, or may be disposed outwardly from the opposite ends, which are disposed in the second direction, of the second electrode body 320 in the second direction.

Even in the instant case, in the pressing step (30), the jig plate 600 presses the first electrode body 220 and the second electrode body 320 without pressing at least one first electrode tab 230 and at least one second electrode tab 330. Accordingly, the at least one first electrode tab 230 and the at least one second electrode tab 330 may be prevented from being broken by the jig plate 600. Accordingly, the productivity of the all-solid-state battery 100 may be improved.

Hereinafter, the breakage rate of the first electrode tab 230 and the second electrode tab 330 made in the unit pressing stack structures 100a, 100b, 100c, 100d, 100e, and 100f described above with reference to FIGS. 3 and 8, and the isostatic pressing process according to a comparative example will be described with reference to following table 1.

TABLE 1
<Failure rates of the first and second electrode tabs made in the unit pressing
stack structure according to an exemplary embodiment of the present disclosure
and the isostatic pressing process according to a comparative example>

| | | Unit | Unit | Unit | Unit | Unit | Unit |
|---|---|---|---|---|---|---|---|
| | | pressing | pressing | pressing | pressing | pressing | pressing |
| | | stack | stack | stack | stack | stack | stack |
| Breakage | Comparative | structure | structure | structure | structure | structure | structure |
| rate | example | (100a) | (100b) | (100c) | (100d) | (100e) | (100f) |
| First | 50% | 4% | 4% | 2% | 3% | 2% | 4% |
| electrode | | | | | | | |
| tab 230 | | | | | | | |
| First | 92% | 12% | 9% | 4% | 3% | 4% | 6% |
| electrode | | | | | | | |
| tab 330 | | | | | | | |

Table 1 shows the breakage rates of the first electrode tab 230 and the second electrode tab 330 made in the unit pressing stack structures 100a, 100b, 100c, 100d, 100e, and 100f according to various exemplary embodiments of the present disclosure, and an isostatic pressing process performed for 30 minutes under the environment of 100 degrees Celsius according to a comparative example.

In the instant case, according to the comparative example, the opposite ends, which are disposed in the second direction, of the jig plate may be disposed outwardly from the opposite ends, which are disposed in the second direction, of the first electrode body in the second direction. According to the comparative example, it may be recognized that the isostatic pressing process causes the breakage rate of 50% in the first electrode tab and the breakage rate of 92% in the second electrode tab.

It may be recognized that the unit pressing stack structure 100a illustrated in FIG. 3 show the breakage rate of 4% in the first electrode tab 230 and the breakage rate of 12% in the second electrode tab 330 through the isostatic pressing process.

It may be recognized that the unit pressing stack structure 100b illustrated in FIG. 4 show the breakage rate of 4% in the first electrode tab 230 and the breakage rate of 9% in the second electrode tab 330 through the isostatic pressing process.

It may be recognized that the unit pressing stack structure 100c illustrated in FIG. 5 show the breakage rate of 2% in the first electrode tab 230 and the breakage rate of 4% in the second electrode tab 330 through the isostatic pressing process.

It may be recognized that the unit pressing stack structure 100d illustrated in FIG. 6 show the breakage rate of 3% in the first electrode tab 230 and the breakage rate of 3% in the second electrode tab 330 through the isostatic pressing process.

It may be recognized that the unit pressing stack structure 100e illustrated in FIG. 7 show the breakage rate of 2% in the first electrode tab 230 and the breakage rate of 4% in the second electrode tab 330 through the isostatic pressing process.

To the contrary, it may be recognized that the unit pressing stack structure 100f illustrated in FIG. 8 show the breakage rate of 4% in the first electrode tab 230 and the breakage rate of 6% in the second electrode tab 330 through the isostatic pressing process.

Accordingly, when compared with the comparative example, the breakage rates of the first and second electrode tabs 230 and 330, which are caused through the isostatic pressing process for the unit pressing stack structures 100a, 100b, 100c, 100d, 100e, and 100f, may be remarkably reduced. Therefore, according to the method for manufacturing the all-solid-state battery 100 (see FIG. 1) of the present disclosure, the productivity of the all-solid-state battery 100 may be improved.

The unit pressing stack structures 100a, 100b, 100c, 100d, 100e, and 100f, which are described above, are not limited to the structure illustrated in FIGS. 3 to 8. For example, the first and second electrode tabs 230 and 330 of the unit pressing stack structures 100a, 100b, 100c, 100d, 100e, and 100f may be disposed to extend in the first direction and make close contact with opposite sides of the at least one first electrode 200 and the at least one second electrode 300 in the second direction, respectively.

According to an exemplary embodiment of the present disclosure, the isostatic pressing process may be performed in the state that the electrode tab is spaced apart from the jig plate, preventing the electrode tab from being broken so that the productivity of the all-solid-state battery is improved.

Besides, a variety of effects directly or indirectly understood through the disclosure may be disposed.

The above description is merely an example of the technical idea of the present disclosure, and various modifications and modifications may include one skilled in the art without departing from the essential characteristic of the present disclosure.

Therefore, the exemplary embodiments of the present disclosure are disposed to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An all-solid-state battery comprising:
a plurality of first electrodes, each first electrode including a first electrode current collector including a first electrode body and a first electrode tab, and a first electrode active material disposed on the first electrode current collector;
a plurality of second electrodes having a polarity different from a polarity of the plurality of first electrodes, and alternately stacked with the plurality of first electrodes in a first direction, each second electrode including a second electrode current collector including a second electrode body and a second electrode tab, and a second electrode active material disposed on the second electrode current collector; and
a solid electrolyte interposed between each first electrode and each second electrode,
wherein each first electrode tab and each second electrode tab protrude from the first electrode body and the second electrode body, respectively, in a second direction crossing the first direction, and
wherein a part, in which the first electrode tabs of the plurality of first electrodes make contact with each other, or a part, in which the second electrode tabs of the plurality of second electrodes make contact with each other, is spaced apart in the first direction from the first electrode or the second electrode, which is positioned at opposite ends, which are disposed in the first direction, of the plurality of first electrodes and the plurality of second electrodes.

2. The all-solid-state battery of claim 1,
wherein the first electrode tabs of the plurality of first electrodes make contact with each other at one side of the first electrode body and the second electrode body in the second direction, and
wherein the second electrode tabs of the plurality of second electrodes make contact with an opposite side of the first electrode body and the second electrode body in the second direction.

3. The all-solid-state battery of claim 2, wherein the first electrode active material has an area greater than an area of the second electrode active material.

4. The all-solid-state battery of claim 2, further including:
an edge member disposed along a circumference of the second electrode active material to make contact with the second electrode tab.

5. The all-solid-state battery of claim 1,
wherein the first electrode is disposed as an anode, and
wherein the second electrode is disposed as a cathode.

6. A method for providing an all-solid-state battery, the method comprising:
stacking, in a first direction, at least one first electrode, at least one second electrode disposed to have a polarity different from a polarity of the at least one first electrode, and at least one solid electrolyte interposed between the at least one first electrode and the at least one second electrode;
stacking the at least one first electrode, the at least one second electrode, and the at least one solid electrolyte, on a jig plate and packing a result structure using an exterior material; and
pressing the at least one first electrode, the at least one solid electrolyte, the at least one second electrode, which are stacked on each other, which are packed, in the first direction,
wherein the first electrode includes:
a first electrode current collector including a first electrode body and a first electrode tab protruding from the first electrode body, in a second direction crossing the first direction,
wherein the second electrode includes:
a second electrode current collector including a second electrode body and a second electrode tab protruding from the second electrode body in the second direction, and
wherein the at least one first electrode, the at least one second electrode, and the at least one solid electrolyte are stacked on the jig plate and the first electrode tab and the second electrode tab are spaced apart from the jig plate in the first direction.

7. The method of claim 6, wherein opposite ends, which are disposed in the second direction, of the jig plate are disposed inwardly from opposite ends, which are disposed in the second direction, of the first electrode body in the second direction, or disposed at positions in line with positions of the opposite ends, which are disposed in the second direction, of the first electrode body, in the first direction.

8. The method of claim 6, wherein each of opposite ends, which are disposed in the second direction, of the jig plate is disposed between each of opposite ends, which are disposed in the second direction, of the first electrode body, and each of opposite ends, which are disposed in the second direction, of the second electrode body.

9. The method of claim 6, wherein the packing of the at least one first electrode, the at least one solid electrolyte, the at least one second electrode, using the exterior material includes:
additionally disposing a protective film between the jig plate, and the first electrode or the second electrode, which is positioned at one end portion, which is disposed in the first direction, of the at least one first electrode and the at least one second electrode, and packing the protective film together with the at least one first electrode, the at least one solid electrolyte and the at least one second electrode using the exterior material.

10. The method of claim 9, wherein opposite ends, which are disposed in the second direction, of the protective film are disposed outwardly from opposite ends, which are disposed in the second direction, of the jig plate in the second direction, or disposed at positions in line with positions of the opposite ends, which are disposed in the second direction, of the jig plate, in the first direction.

11. The method of claim 6, wherein the packing of the at least one first electrode, the at least one solid electrolyte, the at least one second electrode, using the exterior material further includes:
packing an internal exterior material and the jig plate together using the exterior material so that the internal exterior material and the jig plate are surrounded by the exterior material, after surrounding the at least one first electrode, the at least one solid electrolyte, and the at least one second electrode by the internal exterior material.

12. The method of claim 6, wherein the jig plate includes:
a jig plate body; and
a jig plate cover disposed at opposite sides of the jig plate body in the second direction, and
wherein the jig plate cover includes an elastic member.

13. The method of claim 12, wherein opposite ends, which are disposed in the second direction, of the jig plate are disposed inwardly from opposite ends, which are disposed in the second direction, of the first electrode body in the second direction, or disposed at positions in line with positions of the opposite ends, which are disposed in the second direction, of the first electrode body, in the first direction.

14. The method of claim 12, wherein each of opposite ends, which are disposed in the second direction, of the jig plate cover are interposed between each of opposite ends, which are disposed in the second direction, of the first electrode body and each of opposite ends, which are disposed in the second direction, of the second electrode body.

15. The method of claim 6, further comprising:
unpacking the exterior material packed, after pressing the at least one first electrode, the at least one solid electrolyte, and the at least one second electrode, which are packed, and additionally stacking a plurality of first electrodes, a plurality of solid electrolytes, and a plurality of second electrodes.

16. The method of claim 15, further comprising:
bringing first electrode tabs of the plurality of first electrodes into contact with each other and bonding the first electrode tabs to a first lead and bringing second electrode tabs of the plurality of second electrodes into contact with each other and bonding the second electrode tabs to a second lead, after stacking the plurality of first electrodes, the plurality of solid electrolytes, and the plurality of second electrodes.

17. The method of claim 16, further comprising:
packing the plurality of first electrodes, the plurality of solid electrolytes, and the plurality of second electrodes, which are stacked, using a post exterior material.
